(19) United States
(12) Patent Application Publication
(10) Pub. No.: US 2005/0094506 A1
(43) Pub. Date: May 5, 2005

(54) Recording and reproducing method, recording and reproducing device and semiconductor circuit

(76) Inventors: Tetsuya Shihara, Kadoma city (JP); Hiromichi Ishibashi, Ibaraki city (JP); Yuu Okada, Moriguchi city (JP)

Correspondence Address: WENDEROTH, LIND & PONACK, L.L.P., 2033 K STREET N. W., SUITE 800, WASHINGTON, DC, 20006-1021, US

(21) Appl. No.: 10/949,329

(22) Filed: Sep. 27, 2004

(30) Foreign Application Priority Data
Oct. 29, 2003 (JP) 2003-368648

(51) Int. Cl. G11B 7/00

(52) U.S. Cl. 369/44.26; 369/47.27

(57) ABSTRACT

An optical disk information recording and reproducing device (100), which is used for recording and reproducing information on an optical disk (10), includes a system controller (19), a tracking control portion (15), a focus control portion (16) and an aberration correction portion (17). The system controller (19) adjusts a control parameter for recording and reproducing control of the optical disk (10) by using a tracking error signal TE that is detected from an region (30) having a wide track pitch on the optical disk (10). The tracking control portion (15), the focus control portion (16) and the aberration correction portion (17) record and reproduce information on the optical disk (10) by using the adjusted control parameter.

### BACKGROUND OF THE INVENTION

1. Field of the Invention

The present invention relates to a method and a device for recording and reproducing information on an optical disk, and a semiconductor circuit that is used for the recording and reproducing device.

2. Description of the Prior Art

Recently, optical disk media such as DVDs (Digital Versatile Discs) and optical disk devices are being used widely. In addition, a blu-ray optical disk using a blue laser that enables a higher density of recording than a DVD that uses a red laser has become commercially practical. While the wavelength of the laser that is used for recording and reproduction of the optical disk has decreased, a numerical aperture (NA) of an objective lens has increased so as to decrease the light spot on the optical disk.

However, the influence of a wave aberration of the light spot has become non-negligible as a recording pit or a recording mark becomes more minute. Therefore, a method for correcting a spherical aberration has been proposed (see Japanese unexamined patent publication No. 11-25906, for example). As a method for correcting such an aberration, it is common to move a coupling lens disposed on an optical axis or a collimator lens for collimating the laser beam in the direction of the optical axis.

FIG. 2 shows an example of a head structure for correcting the spherical aberration.

As shown in FIG. 2, a light source 24 such as a semiconductor laser emits light, which passes through a deflection prism 25 and enters a collimator lens 23. Next, the collimator lens 23 collimates the light, which enters an objective lens 26 and is condensed by the objective lens 26 so as to be focused on an optical disk 20. In addition, the objective lens 26 forms a predetermined light spot on the optical disk 20 so as to trace the course of a desired track by driving an actuator 21. Light reflected by the optical disk 20 enters the objective lens 26 again so as to be collimated and again enters the collimator lens 23. After passing through the collimator lens 23, the light again enters the deflection prism 25 and is deflected this time to enter a hologram 27 that is an optical filter for detecting a desired signal. After passing through the hologram 27, the light enters a photo detector 28 that generates various control signals.

In this structure, the collimator lens 23 is moved by a drive actuator 22 so that a spherical aberration is corrected. This is a known technique for correcting a spherical aberration.

In addition, for an optical disk device, a method of finding an appropriate quantity of correction has been proposed in which a signal recorded on the optical disk is used for correcting the aberration (see Japanese unexamined patent publication No. 10-106012, for example).

Furthermore, another method for correcting the aberration has been proposed, in which a focus error signal is used in the optical head for changing the focus position and amount of aberration correction at a constant ratio (see Japanese unexamined patent publication No. 2000-182254).

In the above-mentioned conventional structures, there are differences between optical disk devices and optical elements when setting a control parameter for a recording and reproducing control, such as a focus position or quantity of aberration, at predetermined values. Therefore, an appropriate recording and reproducing control is not always performed.

In addition, to set a control parameter by reproducing a signal recorded on the optical disk, the device structure and control will be complicated.

Furthermore, to set a control parameter by using a focus error signal, the structure of the optical head will be complicated.

As described above, an easier and more appropriate method is desired for setting a control parameter for recording and reproducing control.

### SUMMARY OF THE INVENTION

An object of the present invention is to provide a recording and reproducing method that enables an easier and more appropriate setting of a control parameter for recording and reproducing control. Another object of the present invention is to provide a recording and reproducing device and a semiconductor circuit that allows an easier and more appropriate setting of a control parameter.

According to a first aspect of the present invention, a recording and reproducing method is provided, which is a method for recording and reproducing information on an optical disk and includes a parameter adjustment step and a recording and reproducing execution step. The parameter adjustment step is for adjusting a control parameter for a recording and reproducing control of the optical disk by using a detected signal that is detected from a region having a predetermined track pitch on the optical disk. The recording and reproducing execution step is for recording and reproducing information on the optical disk by using the adjusted control parameter.

Here, the detected signal is a signal that is obtained by utilizing the physical shape or characteristics of the optical disk, for example.

The recording and reproducing method according to the present invention utilizes the detected signal for adjusting a control parameter, so it is possible to adjust the control parameter appropriately. Furthermore, the detected signal is detected from the region having the predetermined track pitch, so the control parameter can be set more readily. Thus, a recording and reproducing method that achieves an easier and more appropriate setting of a control parameter can be provided.

According to a second aspect of the present invention in the recording and reproducing method, the detected signal is a tracking control signal that is used for tracking a light spot in the region having the predetermined track pitch. The light spot is for recording and reproducing information on the optical disk.

In the recording and reproducing method of the present invention, the tracking control signal is utilized for adjusting a control parameter. Namely, the tracking control that is similar to when recording and reproducing information on the optical disk enables the adjustment of a control parameter, so that the control parameter can be set more readily.

According to a third aspect of the present invention in the recording and reproducing method, the tracking control signal is a tracking error signal that is a differential output of a photo detector portion for detecting reflected light of the light spot. The parameter adjustment step includes adjusting the control parameter so that a signal amplitude of the tracking error signal becomes the maximum value.

It has been found by the present inventors that the adjustment of a control parameter is performed appropriately when a signal amplitude of the tracking error signal becomes the maximum value.

In the recording and reproducing method of the present invention, the tracking error signal that is similar to when recording and reproducing information on the optical disk can be used for the adjustment of a control parameter.

According to a fourth aspect of the present invention in the recording and reproducing method, the recording and reproducing control includes a focus control for substantially stabilizing a light spot for recording and reproducing information on the optical disk and an aberration correction control for correcting an optical aberration of the light spot.

According to a fifth aspect of the present invention in the recording and reproducing method, the aberration correction control is a control for correcting a spherical aberration.

According to a sixth aspect of the present invention in the recording and reproducing method, the parameter adjustment step includes finding optimal control positions for the focus control and the aberration correction control in the region having the predetermined track pitch.

The recording and reproducing method of the present invention enables adjustment of optimal control positions (control parameters) of the focus control and the aberration correction control in the region having the predetermined track pitch.

According to a seventh aspect of the present invention in the recording and reproducing method, the region having the predetermined track pitch is a region that is formed so that information cannot be recorded on the optical disk.

The region that is formed so that information cannot be recorded on the optical disk is a region for adding information of the optical disk or the like during or after the optical disk is manufactured. For example, it may be a burst cutting area (BCA) that is formed on the optical disk.

According to an eighth aspect of the present invention in the recording and reproducing method, the region having the predetermined track pitch is a region that is formed at the inner part of the optical disk.

According to a ninth aspect of the present invention in the recording and reproducing method, the track pitch of the optical disk is formed so as to enable tracking control in which a light spot generated by one light source can trace the course of a desired track in every region.

According to a tenth aspect of the present invention in the recording and reproducing method, the optical disk includes grooves having different track pitches in each region of the optical disk. The region having the predetermined track pitch is a region having a wide track pitch among the regions having different track pitches. The recording and reproducing execution step includes recording and reproducing information on the optical disk in a region having a narrow track pitch among the regions having different track pitches.

In the recording and reproducing method of the present invention, the adjustment of a control parameter is performed in a region having a wide track pitch, and the recording and reproducing processes are performed in a region having a narrower track pitch.

According to an eleventh aspect of the present invention in the recording and reproducing method, the region having the predetermined track pitch is a region having a track pitch which is twice or more the diameter of the light spot for recording and reproducing information on the optical disk.

In the recording and reproducing method of the present invention, the adjustment of a control parameter is performed in a region having a track pitch which is twice or more the diameter of the light spot.

According to a twelfth aspect of the present invention in the recording and reproducing method, the optical disk includes grooves having different track pitches in each region of the optical disk. The region having the predetermined track pitch is a region having a wide track pitch among the regions having different track pitches. A region having a narrow track pitch among the regions having different track pitches is a region having a track pitch which is twice or less the diameter of the light spot.

In the recording and reproducing method of the present invention, the adjustment of a control parameter is performed in a region having a track pitch which is twice or more the diameter of the light spot, and the recording and reproducing processes can be performed in a region having a track pitch which is twice or less the diameter of the light spot.

According to a thirteenth aspect of the present invention in the recording and reproducing method, (TPW/λ)*NA is within the range of 3.69-4.95 when TPW represents the track pitch of the region having the predetermined track pitch, λ represents a wavelength of light that is irradiated onto the optical disk, and NA represents a numerical aperture of an objective lens for condensing light.

In the recording and reproducing method of the present invention, the adjustment of a control parameter can be performed in a region having a value of (TPW/λ)*NA within the range of 3.69-4.95.

According to a fourteenth aspect of the present invention in the recording and reproducing method, the optical disk includes grooves having different track pitches in each region of the optical disk. The region having the predetermined track pitch is a region having a wide track pitch among the regions having different track pitches. A value of (TPS/λ)*NA is within the range of 0.61-0.73 when TPS represents a track pitch of a region having a narrow track pitch among the regions having different track pitches.

In the recording and reproducing method of the present invention, the adjustment of a control parameter is performed in a region of TPW in which (TPW/λ)*NA is within the range of 3.69-4.95, and recording and reproducing can be performed in a region of TPS in which (TPS/λ)*NA is within the range of 0.61-0.73.

According to a fifteenth aspect of the present invention, a recording and reproducing device is provided, which is a device for recording and reproducing information on an optical disk, and includes a parameter adjustment portion and a recording and reproducing execution portion. The parameter adjustment portion adjusts a control parameter for recording and reproducing control of the optical disk by using a detected signal that is detected from a region having a predetermined track pitch on the optical disk. The recording and reproducing execution portion records and reproduces information on the optical disk by using the adjusted control parameter.

Here, the detected signal is, for example, a signal that is obtained by utilizing the physical shape or characteristics of an optical disk.

In the recording and reproducing device of the present invention, the detected signal is used for the adjustment of a control parameter so that the control parameter can be set appropriately. Furthermore, the detected signal is detected from a region having the predetermined track pitch, so the control parameter can be set more readily. Thus, a recording and reproducing device that achieves an easier and more appropriate setting of a control parameter can be provided.

According to a sixteenth aspect of the present invention in the recording and reproducing device, the detected signal is a tracking control signal that is used for tracking a light spot in the region having the predetermined track pitch. The light spot is for recording and reproducing information on the optical disk.

In the recording and reproducing device of the present invention, the tracking control signal is used for the adjustment of a control parameter. Namely, the tracking control that is similar to when recording and reproducing information on the optical disk enables the adjustment of a control parameter, so that the control parameter can be set more readily.

According to a seventeenth aspect of the present invention in the recording and reproducing device, the tracking control signal is a tracking error signal that is a differential output of a light reception portion for receiving reflected light of the light spot. The parameter adjustment portion adjusts the control parameter so that a signal amplitude of the tracking error signal becomes the maximum value.

It has been found by the present inventors that the adjustment of a control parameter is performed appropriately when a signal amplitude of the tracking error signal becomes the maximum value.

In the recording and reproducing device of the present invention, the tracking error signal that is similar to when recording and reproducing information on the optical disk can be used for the adjustment of a control parameter.

According to an eighteenth aspect of the present invention in the recording and reproducing device, the recording and reproducing control includes a focus control for substantially stabilizing a light spot for recording and reproducing information on the optical disk and an aberration correction control for correcting an optical aberration of the light spot.

According to a nineteenth aspect of the present invention in the recording and reproducing device, the aberration correction control is a control for correcting a spherical aberration.

According to a twentieth aspect of the present invention in the recording and reproducing device, the parameter adjustment portion finds optimal control positions for the focus control and the aberration correction control in the region having the predetermined track pitch.

The recording and reproducing device of the present invention enables adjustment of optimal control positions (control parameters) of the focus control and the aberration correction control in the region having the predetermined track pitch.

According to a twenty-first aspect of the present invention in the recording and reproducing device, the region having the predetermined track pitch is a region that is formed so that information cannot be recorded on the optical disk.

The region that is formed so that information cannot be recorded on the optical disk is a region for adding information of the optical disk or the like during or after the optical disk is manufactured. For example, it may be a burst cutting area (BCA) that is formed on the optical disk.

According to a twenty-second aspect of the present invention in the recording and reproducing device, the region having the predetermined track pitch is a region that is formed at the inner part of the optical disk.

According to a twenty-third aspect of the present invention in the recording and reproducing device, the track pitch of the optical disk is formed so as to enable a tracking control in which a light spot generated by one light source can trace the course of a desired track in every region.

According to a twenty-fourth aspect of the present invention in the recording and reproducing device, the optical disk includes grooves having different track pitches in each region of the optical disk. The region having the predetermined track pitch is a region having a wide track pitch among the regions having different track pitches. The recording and reproducing execution portion records and reproduces information on the optical disk in a region having a narrow track pitch among the regions having different track pitches.

In the recording and reproducing device of the present invention, the adjustment of a control parameter is performed in a region having a wide track pitch, and the recording and reproducing processes are performed in a region having a narrower track pitch.

According to a twenty-fifth aspect of the present invention in the recording and reproducing device, the region having the predetermined track pitch is a region having a track pitch which is twice or more the diameter of the light spot for recording and reproducing information on the optical disk.

In the recording and reproducing device of the present invention, the adjustment of a control parameter is performed in a region having a track pitch which is twice or more the diameter of the light spot.

According to a twenty-sixth aspect of the present invention in the recording and reproducing device, the optical disk includes grooves having different track pitches in each region of the optical disk. The region having the predetermined track pitch is a region having a wide track pitch among the regions having different track pitches. The region having a narrow track pitch among the regions having different track pitches is a region having a track pitch which is twice or less the diameter of the light spot.

In the recording and reproducing device of the present invention, the adjustment of a control parameter is performed in a region having a track pitch which is twice or more the diameter of the light spot, and the recording and reproducing processes can be performed in a region having a track pitch which is twice or less the diameter of the light spot.

According to a twenty-seventh aspect of the present invention in the recording and reproducing device, (TPW/λ)*NA is within the range of 3.69-4.95 when TPW represents a track pitch of the region having the predetermined track pitch, λ represents a wavelength of light that is irradiated onto the optical disk, and NA represents a numerical aperture of an objective lens for condensing light.

In the recording and reproducing device of the present invention, the adjustment of a control parameter can be performed in a region having a value of (TPW/λ)*NA within the range of 3.69-4.95.

According to a twenty-eighth aspect of the present invention in the recording and reproducing device, the optical disk includes grooves having different track pitches in each region of the optical disk. The region having the predetermined track pitch is a region having a wide track pitch among the regions having different track pitches. A value of (TPS/λ)*NA is within the range of 0.61-0.73 when TPS represents a track pitch of a region having a narrow track pitch among the regions having different track pitches.

In the recording and reproducing device of the present invention, the adjustment of a control parameter is performed in a region of TPW in which (TPW/λ)*NA is within the range of 3.69-4.95, and recording and reproducing can be performed in a region of TPS in which (TPS/λ)*NA is within the range of 0.61-0.73.

According to a twenty-ninth aspect of the present invention, a semiconductor circuit is provided, which is used for adjusting a control parameter for recording and reproducing control of an optical disk and includes a detected signal obtaining portion and a parameter adjustment portion. The detected signal obtaining portion obtains a detected signal that is detected from a region having a predetermined track pitch on the optical disk. The parameter adjustment portion adjusts a control parameter of the recording and reproducing control by using the obtained detected signal.

Here, the detected signal is, for example, a signal that is obtained by utilizing the physical shape or characteristics of an optical disk.

In the semiconductor circuit of the present invention, the detected signal is used for the adjustment of a control parameter so that the control parameter can be set appropriately. Furthermore, the detected signal is detected from a region having the predetermined track pitch, so the control parameter can be set more readily. Thus, a semiconductor circuit that achieves an easier and more appropriate setting of a control parameter can be provided.

As described above, the present invention can provide a recording and reproducing method that achieves an easier and more appropriate setting of a control parameter in the control parameter setting for recording and reproducing control.

### BRIEF DESCRIPTION OF THE DRAWINGS

FIG. 1 is a block diagram of an optical disk device according to an embodiment of the present invention.

FIG. 2 shows a head structure for correcting a spherical aberration in the background art.

FIGS. 3(a) and 3(b) show schematically the track region of the optical disk according to an embodiment of the present invention.

FIGS. 4(a) and 4(b) show light distributions of a photo detector in the embodiment of the present invention.

FIG. 5 is a diagram showing an amplitude characteristic of a tracking error signal with respect to a focus position and an aberration correction quantity in the embodiment of the present invention.

FIGS. 6(a)-6(f) show shapes of a light beam and tracking error signals for the spherical aberration in the embodiment of the present invention.

FIG. 7 is a flowchart of a process for finding a focus position value and an aberration correction quantity in the embodiment of the present invention.

FIG. 8 is a structural diagram of a circuit for generating a focus error signal in the embodiment of the present invention.

FIG. 9 shows a head structure for correcting an aberration in the embodiment of the present invention.

### DESCRIPTION OF THE PREFERRED EMBODIMENTS

Hereinafter, a preferred embodiment of the present invention will be described with reference to the attached drawings. In addition, elements having the same functions are denoted by the same reference numerals.

### First Embodiment

This first embodiment of the present invention is characterized particularly in that a tracking error signal TE is utilized for setting control positions (control parameters) of a focus control and an aberration correction control. Furthermore, it is characterized in that the tracking error signal TE is detected in a predetermined region on the optical disk.

[Structure of Optical Disk Information Recording and Reproducing Device]

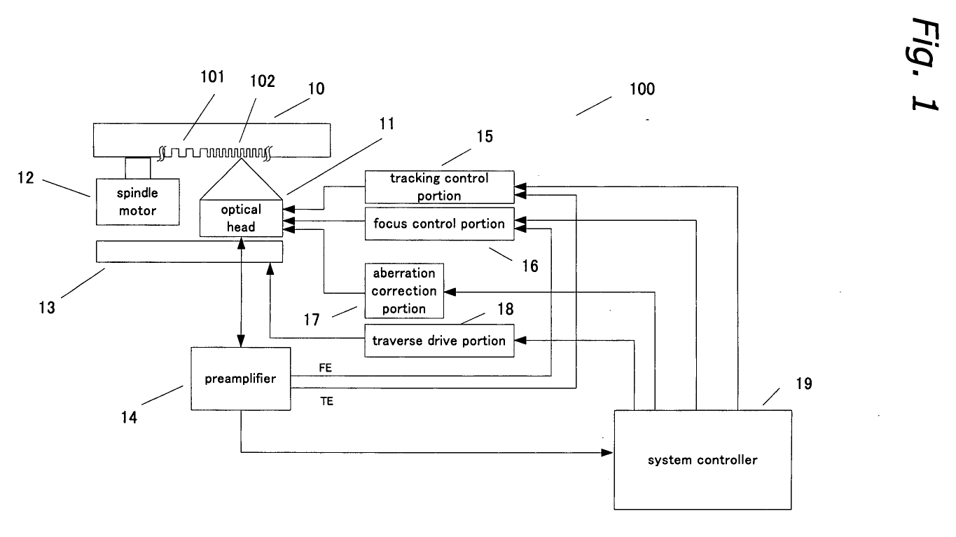

FIG. 1 is a block diagram of an optical disk information recording and reproducing device according to the embodiment of the present invention.

The optical disk information recording and reproducing device 100 includes, as main portions, an optical head 11 for irradiating light onto an optical disk 10 and detecting reflected light from the optical disk 10, a spindle motor 12 for rotating the optical disk 10, a traverse portion 13 for moving the optical head 11, and a traverse drive portion 18 for driving the traverse portion 13. In addition, there is a preamplifier 14 provided which generates a focus error signal (FE), a tracking error signal (TE) and an RF reproduction signal from a detected signal that is detected by the optical head 11.

The focus error signal FE is generated by the preamplifier 14 so that the light emitted by the optical head 11 forms a constant spot on the optical disk 10, and enters a focus control portion 16 so as to achieve the focus control.

The tracking error signal TE is generated by the preamplifier 14 so that the light emitted by the optical head 11 traces the course of a desired track on the optical disk 10, and enters a tracking control portion 15 so as to achieve the tracking control.

The focus control portion 16 and the tracking control portion 15 include a digital filter and various filters so as perform feedback control in accordance with the above-mentioned error signal after irradiating light onto a desired spot on the optical disk 10.

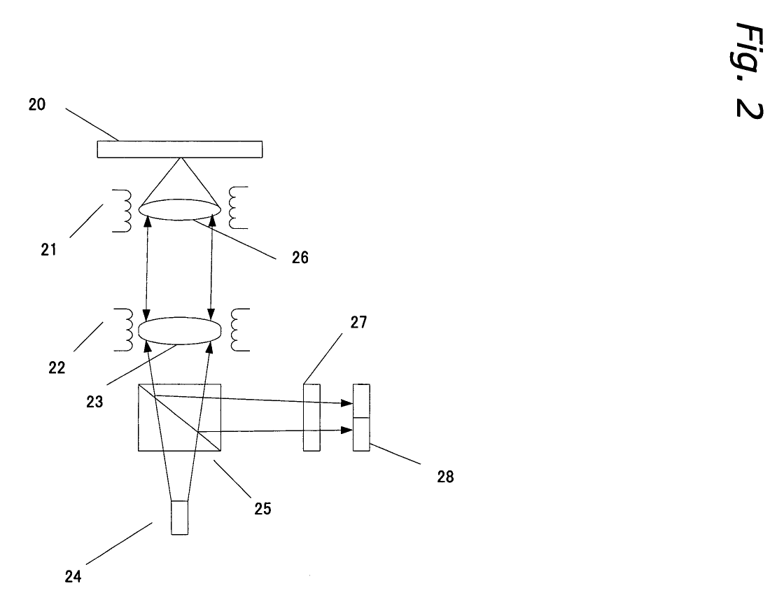

The optical disk information recording and reproducing device 100 further includes an aberration correction portion 17 having the same effect as shown in FIG. 2 so as to perform an aberration correction.

In addition, the optical disk information recording and reproducing device 100 includes a system controller 19 for controlling the entire device. This system controller includes an A/D converter, a digital signal processor (DSP), a central processing unit (CPU) and a memory, so as to perform an optical disk system control by hardware or software. The system controller 19 can detect various error signals generated in the preamplifier 14 or the like, so as to instruct operations and to set an offset or the like for the tracking control portion 15, the focus control portion 16 and the aberration correction portion 17.

[Operation of Optical Disk Information Recording and Reproducing Device]

Hereinafter, the focus control, the aberration correction control and the tracking control of the optical disk information recording and reproducing device 100 will be described. Furthermore, setting of the focus position and the aberration correction quantity (control parameters) will be described, which is performed by using the tracking error signal that is used in the tracking control, which is a characterizing portion of the present invention.

Note that the optical disk information recording and reproducing device 100 uses the focus control, the aberration correction control, the tracking control and the like as described below so as to move the optical head 11 to a desired position on the optical disk 10 and to irradiate a light beam onto a predetermined track for recording or reproducing information. In the following description, the characterizing portion of the present invention will be mainly described. A sequential operation of recording and reproducing can be done by using a recording and reproducing method for a general optical disk device, so the other portions regarding the recording and reproducing operation are not shown in the drawings.

[Focus Control]

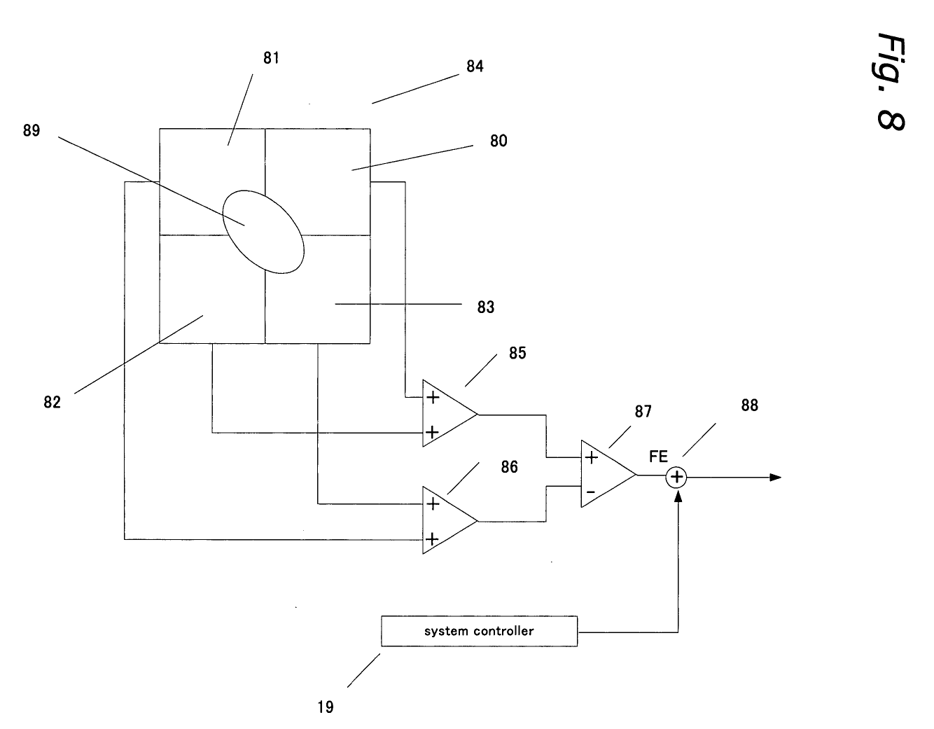

A method for generating the focus error signal FE and a method for changing an offset will be described with reference to FIG. 8.

FIG. 8 is a structural diagram of a circuit for generating the focus error signal FE.

FIG. 8 shows a photo detector 84, adding amplifiers 85 and 86 and a differential amplifier 87. The photo detector 84 is arranged in the above-mentioned optical head 11. In addition, the contour of light distribution 89 on the photo detector 84 becomes circular in a focused state and becomes oval in a defocused state. This variation is detected by four divided regions, which are the region 80, the region 81, the region 82 and the region 83. More specifically, detected signals of the region 81 and the region 83 are summed by the adding amplifier 86, while detected signals of the region 82 and the region 80 are summed by the adding amplifier 85. Then, a difference between two outputs of the adding amplifiers 85 and 86 is detected by the differential amplifier 87 so as to generate the focus error signal FE.

In addition, if a change of the focus position is desired, it can be achieved by adding (voltage or current corresponding to a predetermined variation) to (the focus error signal FE), or by subtracting (the voltage or current) from (the focus error signal FE) by the system controller 19. In addition, the focus position can also be changed by changing the subtraction balance of the differential amplifier 87.

Here, the focus control and the tracking control can be achieved by a method that is used in a general optical disk device, so other methods can be used instead of the method described here. Furthermore, the above-mentioned adding amplifiers 85 and 86 and the differential amplifier 87 can be disposed either in the optical head 11 or in the preamplifier 14.

[Aberration Correction Control]

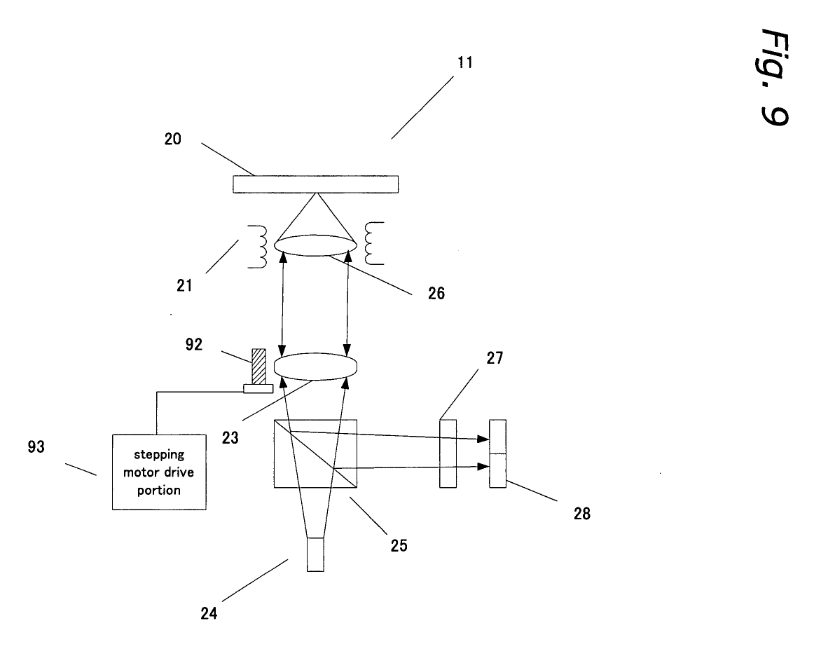

Next, a method for changing aberration correction quantity will be explained with reference to FIG. 9.

FIG. 9 shows an example of a head structure for correcting an aberration. In addition, although the structure shown in FIG. 9 is substantially the same as the structure shown in FIG. 2, the former is different from the latter in that the actuator 22 is replaced with a stepping motor 92 for moving the collimator lens 23 so as to correct the aberration and also in that a stepping motor drive portion 93 is added for operating the collimator lens 23.

In order to correct an aberration that is generated in a light beam, using a signal generated by the preamplifier 14 as a basis, a predetermined value of voltage or current or a command for setting an internal register of the aberration correction portion 17 is delivered from the system controller 19 to the stepping motor drive portion 93, portion 93 also being the aberration correction portion 17. The stepping motor drive portion 93 drives the stepping motor 92 a predetermined amount.

Here, the aberration correction control can be performed by a method that is used in a general optical disk device, so other methods can be used instead of the method described here.

[Tracking Control]

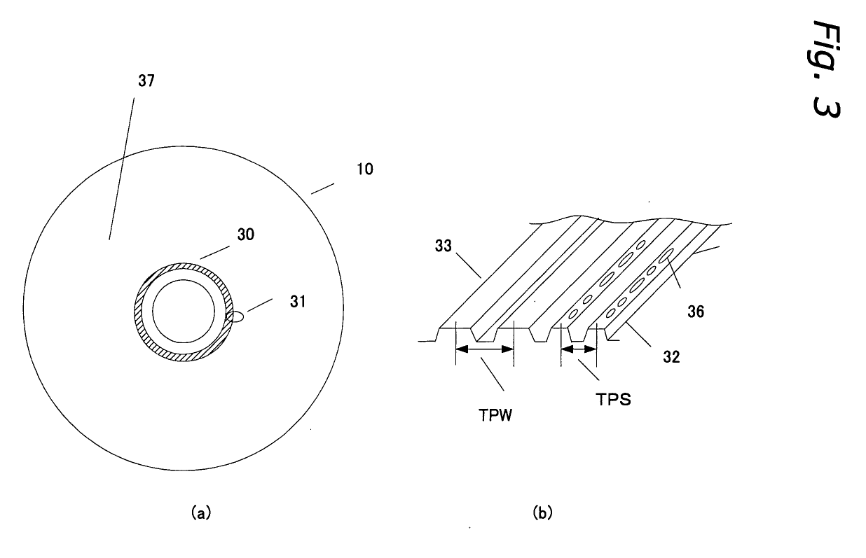

Next, the tracking control of the optical disk information recording and reproducing device 100 will be described with reference to FIGS. 3-7.

[Structure of Disk]

First, a structure of the optical disk 10 that is an object of the tracking control will be described.

The optical disk 10 includes a region 30 having a wide track pitch and a region 37 having a narrow track pitch for implementing the present invention. A track region of this optical disk 10 will be described with reference to FIGS. 3(a) and 3(b).

FIGS. 3(a) and 3(b) show the track region of the optical disk 10 schematically.

The optical disk 10 shown in FIG. 3(a) is provided with the region 30 having a wide track pitch at the inner portion of the disk (the region with hatching) and the region 37 having a narrow track pitch for recording user data at the outer portion.

FIG. 3(b) shows an enlarged part 31 of a portion bordering between the region 30 having a wide track pitch and the region 37 having a narrow track pitch shown in FIG. 3(a).

A track 33 of the optical disk has a groove shape used for a tracking operation by irradiating a light beam. The track 33 is a track having a wide track pitch, which cannot record user information. On the contrary, the track 32 is a track having a narrow track pitch, which can record user information 36. The user information 36 is recorded as a code modulated mark or a pit.

Here, the size of the track pitch is as follows. When the numerical aperture NA of the objective lens is 0.85 and the wavelength of the irradiated laser is 405 nm, the track pitch TPW of the region 30 having a wide track pitch is, for example, 2 microns, while the track pitch TPS of the region 37 having a narrow track pitch is, for example, 0.32 microns. In addition, if the track pitch is too wide or too narrow in this track structure, the tracking error signal TE cannot be produced correctly. Therefore, it is preferable that a value obtained by dividing the track pitch TPW by the wavelength λ of the light beam and by multiplying the result by the numerical aperture NA of the objective lens be within the range of approximately 3.69-4.95. Furthermore, it is preferable that a value obtained by dividing the track pitch TPS by the wavelength λ of the light beam and by multiplying the result by the numerical aperture NA of the objective lens be within the range of approximately 0.61-0.73.

Here, the region 30 having a wide track pitch means a region that is formed at the inside portion of the optical disk and is called a burst cutting area (BCA). The BCA is provided for adding information to the optical disk during or after the optical disk is manufactured. The BCA is formed in a striped pattern in a circumferential manner for reading the variation of a reflection factor.

The BCA is generally formed by a high power laser after the disk is manufactured, but a preformed track enables tracking control after the BCA is formed.

[Tracking Control]

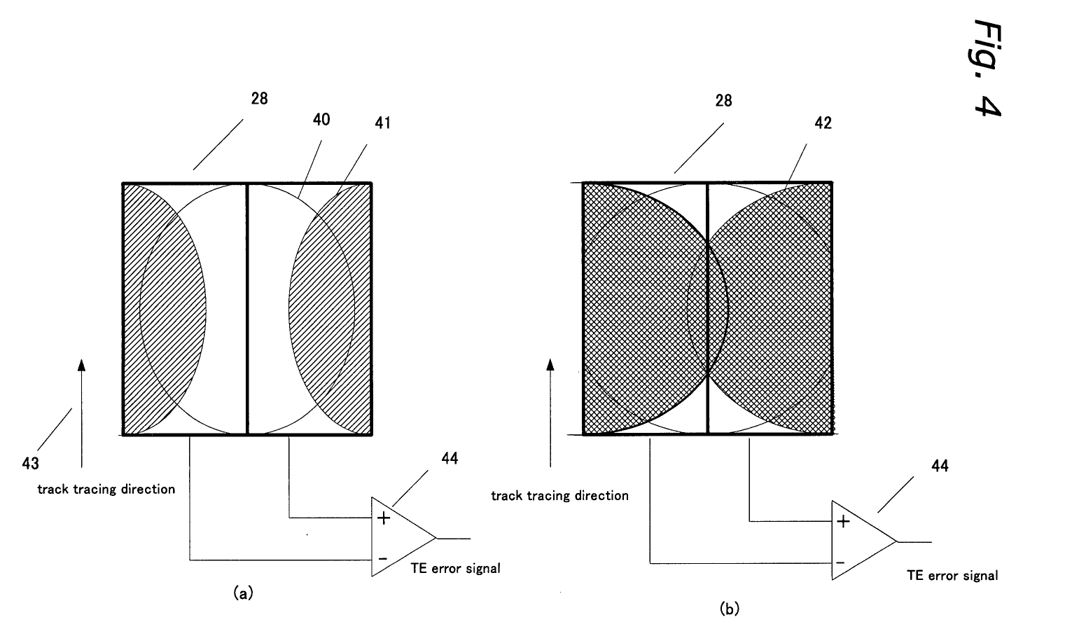

Next, the photo detector 28 and a method for generating the tracking error signal (TE) when reproducing these tracks 32 and 33 will be described with reference to FIG. 4.

FIGS. 4(a) and 4(b) are schematic diagrams showing light distributions of a photo detector 28 in the optical head 11.

FIG. 4(a) shows a light distribution when the region 37, having a narrow track pitch as shown in FIG. 3, is reproduced. The photo detector 28 has a structure that is divided into right and left with respect to a track scanning direction 43. A zero order diffraction light 40 and +1/−1 order diffraction light 41 of the reflected light from the track 32 are shown with hatching. The tracking error signal TE is generated by the differential amplifier 44, which detects a difference between light quantities detected at the right and left sides of the photo detector 28 separately.

FIG. 4(b) shows a light distribution when the region 30, having a wide track pitch as shown in FIG. 3, is reproduced. As shown in FIG. 4(b), the light distribution moves so that a distance of distributions between +1 and −1 order diffraction light 42 decreases.

Here, a mechanism for changing the light distribution on the photo detector 28 shown in FIG. 4 will be described.

The tracking error signal TE is generated by utilizing a diffraction phenomenon of light when it is irradiated onto a diffraction grating. This diffraction light is formed so that zero order light is located in the center, and +1/−1 order light and +2/−2 order light are located further out in this order. Thus, interference patterns or interference spots are formed so as to be separated from the zero order light. When λ represents a wavelength of light and d represents a grating space, an interference space W, which depends on the properties of light, is proportional to (λ/d).

Here, the track pitch of the optical disk 10 can be replaced with the grating space d, and the relationship of a light distribution space on the photo detector 28 can be replaced with the interference space W. Therefore, it is observed that light distributions 41 become further apart as the track pitch becomes narrower, while the light distributions 42 become closer as the track pitch becomes wider.

In order to record or reproduce information on a predetermined track of the optical disk 10, the above-mentioned structure is used for controlling the optical head 11 so that amplitude of the detected tracking error signal TE decreases.

[Setting of a Control Parameter by Using the Tracking Error Signal]

[Characteristics of the Tracking Error Signal]

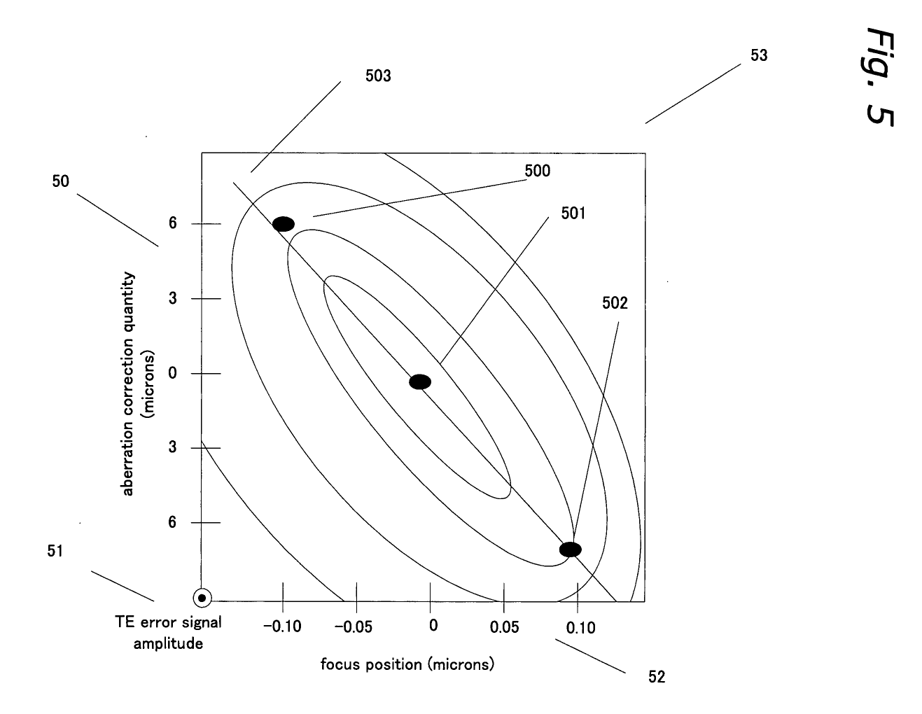

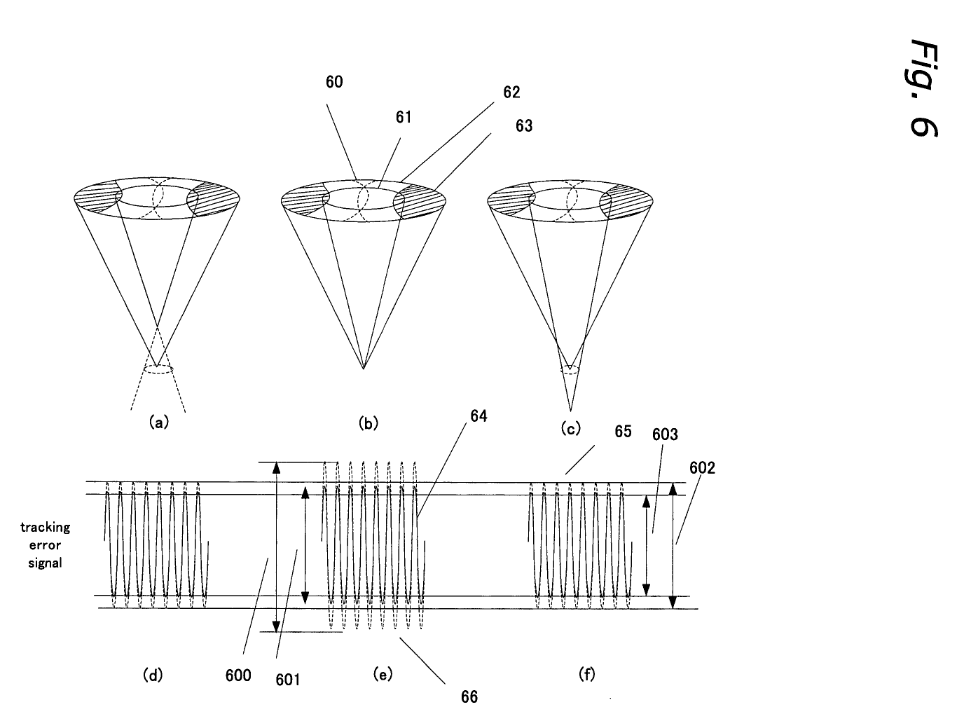

The characteristics of the tracking error signal (TE) that is detected by the focus position and the spherical aberration will be described with reference to FIGS. 5 and 6. FIG. 5 is a diagram showing an amplitude characteristic of a tracking error signal TE with respect to a focus position and an aberration correction quantity. FIG. 6 shows the shape of a light beam and a tracking error signal TE with respect to the spherical aberration.

In FIG. 5, the X axis represents the focus position, the Y axis represents the aberration correction quantity, and the Z axis represents the amplitude of the tracking error signal TE. In FIG. 5, the origin of the X axis and the Y axis indicates the position where the focus is adjusted and the aberration correction is done. Here, the amplitude of the tracking error signal TE becomes the maximum value. When the focus position or the aberration correction quantity changes, the light spot on the optical disk 10 becomes dim so that the amplitude of the tracking signal is decreased. However, the characteristics are such that the decrease of the amplitude of the tracking error signal TE is reduced in the direction where the aberration can be corrected with respect to the change of the focus position. The focus position and the aberration correction quantity are found by using the amplitude characteristics of the tracking error signal TE shown in FIG. 5.

Before describing finding the focus position and the aberration correction quantity, a mechanism of the amplitude variation will be described with reference to FIGS. 6(a)-6(f).

FIGS. 6(a), 6(b) and 6(c) show light beams emitted and condensed by the objective lens, while FIGS. 6(d), 6(e) and 6(f) show outputs of tracking error signals TE that are reproduced and generated corresponding to the light beams.

FIG. 6(b) shows when the focus position and the aberration correction quantity are zero. This corresponds to the point 501 in the diagram shown in FIG. 5. In this situation, focus position of the inner light beam 61 which is the inner portion of the light beam is identical to that of an outer light beam 62 which is the outer portion of the light beam.

FIG. 6(a) shows when an aberration is generated and the focal point of the inner light beam is closer to the objective lens than the focal point of the outer light beam. This corresponds to the point 500 in the diagram shown in FIG. 5. FIG. 6(c), in contrast to FIG. 6(a), shows when the focal point of the inner light beam is farther from the objective lens than the focal point of the outer light beam. This corresponds to the point 502 in the diagram shown in FIG. 5.

In addition, in FIGS. 6(a)-6(c), a light distribution 63 of +1/−1 order diffraction light when reproducing the region 37 having a narrow track pitch (see FIG. 3) is shown with hatching, while a light distribution of +1/−1 order diffraction light when reproducing the region 30 having a wide track pitch (see FIG. 3) is shown with dotted lines.

The present invention is characterized in that a control parameter is searched for in the region 30 having a wide track pitch, so that more reliable searching is achieved. In the present invention, the tracking error signal TE that is generated from the reflected light of the light beam in the region 30 having a wide track pitch is used for setting a control parameter. The reason why the region 30 having a wide track pitch is adopted will be described below.

First, the situation where the region 37 having a narrow track pitch is reproduced will be explained.

If the reflected light has the light distribution 63 and the focal point of the inner light beam is identical to that of the outer light beam, a tracking error signal 64 (shown with a solid line) is produced. On the contrary, even if there is an aberration as shown in FIG. 6(a) or 6(c), the amplitude of the tracking error signal TE fluctuates minimally. Namely, as shown in FIGS. 6(d) and 6(f), there is little difference of amplitude between the tracking error signal 601 and the tracking error signal 603.

Therefore, for the tracking error signal 64 generated from the region 37 having a narrow track pitch, it is difficult to distinguish when the focus position and the aberration correction quantity are optimal from when they are not optimal. It is difficult to find an optimal focus position and optimal aberration correction quantity.

This is because that the tracking error signal TE is generated mainly in accordance with the outer light beam by correcting the aberration in the aberration correction portion 17 (see FIG. 1) when a defocus state is generated and the aberration is also generated. However, the boundary of the inner and outer light beam is continuous, so the amplitude of the tracking error signal TE occasionally decreases even if the aberration is shifted by not an insignificant amount as shown in FIGS. 6(a) and 6(c). Furthermore, the zero order diffraction light increases on the photo detector 28 due to the defocusing, so the contrast in light quantity on the photo detector 28 is reduced as a result.

In addition, there is a possibility that the amplitude of the tracking error signal TE cannot be measured precisely because of variation of the amplitude between the portion where user information is recorded and the portion where the information is not recorded, when finding the focus position and the aberration correction quantity in the region 37 having a narrow track pitch.

Next, the situation where the region 30 having a wide track pitch is reproduced will be described.

In FIG. 6(e), a tracking error signal 66 is shown as a dotted line. Signal amplitude changes substantially in the tracking error signal 66 of the region 30 having a wide track pitch, compared with the tracking error signal 64 of the region 37 having a narrow track pitch. This is because there is an increase in the detected light quantity of the diffraction light for generating the tracking error signal 66. Therefore, signal detection sensitivity increases for the region 37 having a narrow track pitch. Namely, there is a difference of amplitude created between the tracking error signal 600 and the tracking error signal 602. Thus, utilizing this characteristic, optimal set values of the focus position and the aberration correction quantity can be found.

[Setting of a Control Parameter Using the Tracking Error Signal]

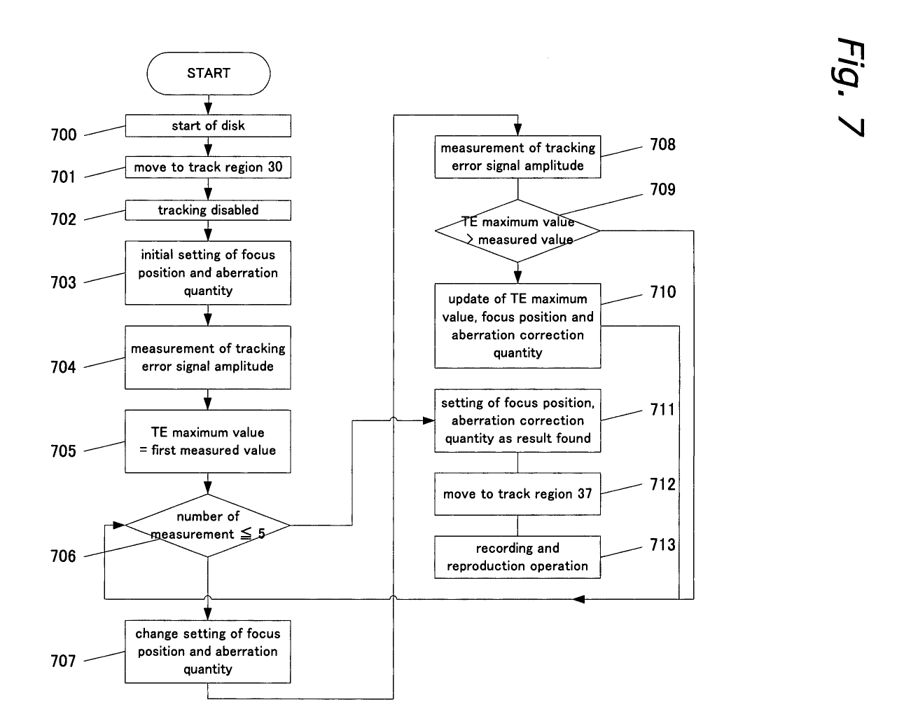

Next, a method for finding an optimal setting of the focus position and the aberration correction quantity will be described with reference to FIG. 7. FIG. 7 is a flowchart of a process for finding a focus position value and an aberration correction quantity.

The optical disk information recording and reproducing device 100 first starts moving the disk (700) and operates the focus control. Next, it drives the traverse portion 13 via the traverse drive portion 18, so that the optical head 11 moves to the region 30 having a wide track pitch at the inner portion of the optical disk 10 (701).

At this time, the tracking control is in a disabled state (702). Namely, in the present invention, a variation of the signal amplitude of the tracking error signal TE with the tracking control in the disabled state is utilized for setting a control parameter.

Next, initial values of the focus position and the aberration correction quantity that have been found are set in the focus control portion 16 and the aberration correction portion 17 by the system controller (703).

Next, the signal amplitude of the tracking error signal TE is measured (704).

Next, a maximum value of the signal amplitude of the tracking error signal TE is stored in an internal memory of the system controller 19 (705).

Next, it is decided whether or not the number of measurement times has reached a predetermined value or more (706).

If it is below the predetermined value, the focus position and the aberration correction quantity are changed (707), and the signal amplitude of the tracking error signal TE is measured (708).

The measured value is compared with the value stored in the internal memory of the system controller 19 (709), and the value stored in the internal memory is updated if it is smaller than the measured value (710). Simultaneously, values of the focus position and the aberration correction quantity at that time are also stored in the memory.

If the measurement result is smaller than the value stored in the internal memory, the next step (706) is performed and the measurement is repeated until the number of measurement times reaches the predetermined value. Though the predetermined value is five in FIG. 7, it is not limited to this value.

If the number of measurement times exceeds the predetermined value (five in this example), the focus position and the aberration correction quantity when the tracking error signal TE is the maximum are set as the result found (711).

Here, in order to change the focus position and the aberration correction quantity, they are moved along a predetermined approximation function in the diagram shown in FIG. 5. In this way, the stability of the tracking control can be secured by finding a portion having a larger amplitude of the tracking error signal TE, and further a two-dimensional search can be performed as a one-dimensional search. The approximation line 503 as shown in FIG. 5 can be used as the approximation function.

Next, the optical head 11 is moved to the track 32 in the region 37 having a narrow track pitch for recording or reproducing information (712), and the tracking control portion 15 is activated for the recording and reproducing operation (713).

In addition, it is possible to prepare a temperature sensor (not shown) or the like so as to find the optimal focus position and aberration correction quantity if necessary even when the temperature of the device changes. Thus, the operation is performed in accordance with a change of the temperature. In addition, it is possible to improve reliability by finding an optimal focus position and an optimal aberration correction quantity again if an error is generated during a reproduction or recording operation.

As described above, according to the present invention, it is possible to find optimal values of the focus position and the aberration correction quantity without reproducing information on the optical disk 10, i.e., without reproducing prerecorded or self-recorded pits or signals on the optical disk 10. Here, “reproduction of pits or signals” means the demodulation of recorded random data.

In addition, it is possible to use the tracking error signal in the region having a wide track pitch for finding optimal values of the focus position and the aberration correction quantity. Thus, an information recording and reproducing device that is simple, has high speed and high reliability can be provided.

In addition, the control parameter can be set by a process similar to the tracking control that is used for recording and reproducing. Thus, the control parameter can be set without any special device, so that a low cost device or simplified device and a process can be achieved.

(Others)

(1) In the present invention, it is possible to use an indicator that changes more extremely when affected by the aberration or the focus position rather than the tracking error signal TE. For example, though the tracking error signal TE shown in FIG. 4 generates a differential output of the detected signals of the detectors, it is possible to use a total light quantity signal that is an output indicating a sum of them.

(2) It is possible to adapt the present invention having the regions having different track pitches as shown in FIG. 3 to other optical disks.

However, it is preferable to detect the tracking error signal TE for setting the control parameter, for example, in a region of track pitch TPW defined as follows. The track pitch TPW has a value such that a value of (TPW/λ)*NA is within the range of 3.69-4.95 when λ represents the wavelength of light that is irradiated onto the optical disk, and NA represents the numerical aperture of the objective lens for condensing light. Furthermore, it is preferable that the track pitch TPS in a region other than the region having the track pitch TPW has a value such that a value of (TPS/λ)*NA is within the range of 0.61-0.73.

In this case, it is possible to set the control parameter in the region of the track pitch TPW and to record or reproduce information in the region of the track pitch TPS.

In addition, the detection of the tracking error signal TE for setting the control parameter can be performed in the region of the next track pitch, for example. Namely, the track pitch has the value that is twice or more the diameter of the light spot formed on the optical disk 10 by light emitted from the optical head 11. It is possible to detect the tracking error signal TE for setting the control parameter in this region. Furthermore, it is preferable that track pitch values of other regions are twice or less the diameter of the light spot.

Then, it is possible to set the control parameter in the region having the track pitch that is twice or more the diameter of the light spot and to record or reproduce information in the region having the track pitch that is twice or less the diameter of the light spot.

(3) Each of the functional blocks in the block diagram and the hardware structure can be an LSI that is an integrated circuit. Each of them may be integrated in a single chip individually. Otherwise, some or all of them may be integrated in a single chip.

For example, the system controller shown in FIG. 1 may be integrated alone in a single chip, or together with other elements constituting the optical disk information recording and reproducing device 100 in a single chip.

Though an LSI is used as described above, it may be also called an IC, a system LSI, a super LSI or an ultra LSI depending on its scale of integration.

In addition, technology for making an integrated circuit is not limited to the LSI, but it can be achieved with a specific circuit or a general purpose processor. It is also possible to utilize a field programmable gate array (FPGA) that can be programmed after manufacturing the LSI or a reconfigurable processor that can reconfigure connection or setting of circuit cells in the LSI.

Furthermore, if another technique for integrating circuits rather than the LSI emerges with progress or a derivation of semiconductor technology, then the technique may be utilized for integrating the functional blocks. Biotechnology has a potential for such a technology.

(Additions)

(Addition 1) A recording or reproducing method for recording and reproducing information on an optical disk having grooves and regions having different track pitches, the method comprising the steps of:
an adjusting control step for recording and reproducing information on the optical disk in an region having a wide track pitch; and
recording or reproducing user information in a region having a narrow track pitch.

(Addition 2) The recording or reproducing method according to Addition 1, wherein the control step includes
a focus control step for substantially stabilizing a light spot for reproducing or recording information on the optical disk, and
an aberration correction step for correcting an optical aberration of the light spot.

(Addition 3) The recording or reproducing method according to Addition 2, wherein optimal control positions of the focus control step and the aberration correction step are found in the region having a wide track pitch.

(Addition 4) The recording or reproducing method according to Addition 2, wherein optimal control positions of the focus control step and the aberration correction step are found in the region having a wide track pitch, which is formed so that information cannot be recorded in different track pitches.

(Addition 5) The recording or reproducing method according to Addition 1, wherein the region having a wide track pitch is formed on the optical disk at a more inner portion than the region having a narrow track pitch.

(Addition 6) The recording or reproducing method according to Addition 3, wherein the optimal control position is found so that a signal amplitude of a tracking error signal for tracing the course of a desired track by the light spot becomes a maximum value when finding the optimal control positions of the focus control step and the aberration correction step.

(Addition 7) The recording or reproducing method according to Addition 1, wherein the different track pitches are formed so as to enable tracking control such that the light spot generated from one light source can trace the course of a desired track in each region on the optical disk.

(Addition 8) The recording or reproducing method according to Addition 1, wherein a value of TPW/λ*NA is within the range of 3.8-4.9, and a value of TPS/λ*NA is within the range of 0.68-0.79 when TPW represents a track pitch of the region having a wide track pitch, TPS represents a track pitch of the region having a narrow track pitch, λ represents a wavelength of light that is irradiated onto the optical disk, and NA represents a numerical aperture of an objective lens for condensing light.

(Addition 9) The recording or reproducing method according to Addition 2, wherein the aberration correction step corrects a spherical aberration.

(Addition 10) An information recording or reproducing device for recording and reproducing information on an optical disk having grooves and regions having different track pitches, comprising
control means for performing an adjustment for recording and reproducing information on an optical disk, wherein
the control means performs the adjustment in a region having a wide track pitch, and
user information is recorded and reproduced in a region having a narrow track pitch.

(Addition 11) The information recording or reproducing device according to Addition 10, wherein the control means includes
focus control means for substantially stabilizing a light spot for reproducing or recording information on the optical disk, and
aberration correction means for correcting an optical aberration of the light spot, and wherein
optimal control positions of the focus control means and the aberration correction means are found in the region having a wide track pitch.

(Addition 12) The information recording or reproducing device according to Addition 11, wherein, for the region having a wide track pitch among the different track pitches, the optimal control positions of the focus control means and the aberration correction means are found by using a region that is formed so that information cannot be recorded.

(Addition 13) The information recording or reproducing device according to Addition 10, wherein the region having a wide track pitch among the different track pitches is formed at a more inner portion than the region having a narrow track pitch on the optical disk.

(Addition 14) The information recording or reproducing device according to Addition 11, wherein the different track pitches are formed so as to enable a tracking control such that the light spot generated from one light source can trace the course of a desired track in each region on the optical disk, and the optimal control positions of the focus control means and the aberration correction means are found.

(Addition 15) The information recording or reproducing device according to Addition 11, wherein the aberration correction means corrects spherical aberration.

(Addition 16) The information recording or reproducing device according to Addition 11, wherein the optimal control position is found so that a signal amplitude of a tracking error signal for tracing a desired track by the light spot becomes a maximum value when finding the optimal control positions of the focus control means and the aberration correction means.

(Description for Additions)

In order to solve the problems of the conventional art, the optical disk information recording and reproducing method as well as the optical disk information recording and reproducing device according to the present invention, which is used for recording and reproducing information on the optical disk having grooves and regions having different track pitches, includes focus control means for substantially stabilizing a light spot for reproducing or recording information on the optical disk, aberration correction means for correcting an optical aberration of the light spot, means for finding optimal control positions of the focus control means and the aberration correction means in the region having a wide track pitch, and means for recording and reproducing user information in the region having a narrow track pitch.

In addition, it is characterized in that a signal amplitude of a tracking error signal is used as an indicator for finding optimal control positions of the focus control means and the aberration correction means.

According to this structure, finding the optimal control position in the region having a wide track pitch enables more precise adjustment of the focus position and the aberration. In addition, it also enables rapid finding of the optimal control position, even if information is not recorded on the disk, since it does not use a reproduction signal of information recorded or formed on the optical disk.

The recording and reproducing method, the recording and reproducing device and the semiconductor device according to the present invention are useful in fields that require easier and more appropriate setting of a control parameter such as an optical disk device for recording and reproducing information on an optical disk.

1. A recording and reproducing method for recording and reproducing information on an optical disk, comprising:
(a) adjusting a control parameter for recording and reproducing control of the optical disk by using a detected signal that is detected from an region having a predetermined track pitch on the optical disk; and
(b) recording and reproducing information on the optical disk by using the adjusted control parameter.

2. The recording and reproducing method according to claim 1, wherein the detected signal is a tracking control signal that is used for tracking a light spot, which is for recording and reproducing information on the optical disk, in the region having the predetermined track pitch.

3. The recording and reproducing method according to claim 1, wherein the tracking control signal is a tracking error signal that is a differential output of a photo detector portion for detecting reflected light of the light spot, and step (a) includes adjusting the control parameter so that a signal amplitude of the tracking error signal becomes the maximum value.

4. The recording and reproducing method according to claim 1, wherein the recording and reproducing control includes a focus control for substantially stabilizing a light spot for recording and reproducing information on the optical disk and an aberration correction control for correcting an optical aberration of the light spot.

5. The recording and reproducing method according to claim 4, wherein the aberration correction control is a control for correcting a spherical aberration.

6. The recording and reproducing method according to claim 4, wherein step (a) includes finding optimal control positions for the focus control and the aberration correction control in the region having the predetermined track pitch.

7. The recording and reproducing method according to claim 1, wherein the region having the predetermined track pitch is an region that is formed so that information cannot be recorded on the optical disk.

8. The recording and reproducing method according to claim 1, wherein the region having the predetermined track pitch is a region that is formed at the inner part of the optical disk.

9. The recording and reproducing method according to claim 1, wherein the track pitch of the optical disk is formed so as to enable tracking control in which a light spot generated by one light source can trace the course of a desired track in every region.

10. The recording and reproducing method according to claim 1, wherein the optical disk includes grooves having different track pitches in each region of the optical disk,
the region having the predetermined track pitch is an region having a wide track pitch among the regions having different track pitches, and
step (b) includes recording and reproducing information on the optical disk in a region having a narrow track pitch among the regions having different track pitches.

11. The recording and reproducing method according to claim 1, wherein the region having the predetermined track pitch is an region having a track pitch which is twice or more the diameter of the light spot for recording and reproducing information on the optical disk.

12. The recording and reproducing method according to claim 11, wherein the optical disk includes grooves having different track pitches in each region of the optical disk,
the region having the predetermined track pitch is an region having a wide track pitch among the regions having different track pitches, and
a region having a narrow track pitch among the regions having different track pitches is a region having a track pitch which is twice or less the diameter of the light spot.

13. The recording and reproducing method according to claim 1, wherein a value of (TPW/λ)*NA is within the range of 3.69-4.95 when TPW represents the track pitch of the region having the predetermined track pitch, λ represents a wavelength of light that is irradiated onto the optical disk, and NA represents a numerical aperture of an objective lens for condensing light.

14. The recording and reproducing method according to claim 13, wherein the optical disk includes grooves having different track pitches in each region of the optical disk,
the region having the predetermined track pitch is a region having a wide track pitch among the regions having different track pitches, and
a value of (TPS/λ)*NA is within the range of 0.61-0.73 when TPS represents a track pitch of a region having a narrow track pitch among the regions having different track pitches.

15. A recording and reproducing device for recording and reproducing information on an optical disk, comprising:
a parameter adjustment portion for adjusting a control parameter for recording and reproducing control of the optical disk by using a detected signal that is detected from a region having a predetermined track pitch on the optical disk; and
a recording and reproducing execution portion for recording and reproducing information on the optical disk by using the adjusted control parameter.

16. The recording and reproducing device according to claim 15, wherein the detected signal is a tracking control signal that is used for tracking a light spot, which is for recording and reproducing information on the optical disk, in the region having the predetermined track pitch.

17. The recording and reproducing device according to claim 15, wherein the tracking control signal is a tracking error signal that is a differential output of a light reception portion for receiving reflected light of the light spot, and the parameter adjustment portion adjusts the control parameter so that a signal amplitude of the tracking error signal becomes the maximum value.

18. The recording and reproducing device according to claim 15, wherein the recording and reproducing control includes a focus control for substantially stabilizing a light spot for recording and reproducing information on the optical disk and an aberration correction control for correcting an optical aberration of the light spot.

19. The recording and reproducing device according to claim 18, wherein the aberration correction control is a control for correcting a spherical aberration.

20. The recording and reproducing device according to claim 18, wherein the parameter adjustment portion finds optimal control positions for the focus control and the aberration correction control in the region having the predetermined track pitch.

21. The recording and reproducing device according to claim 15, wherein the region having the predetermined track pitch is a region that is formed so that information cannot be recorded on the optical disk.

22. The recording and reproducing device according to claim 15, wherein the region having the predetermined track pitch is a region that is formed at the inner part of the optical disk.

23. The recording and reproducing device according to claim 15, wherein the track pitch of the optical disk is formed so as to enable tracking control in which a light spot generated by one light source can trace the course of a desired track in every region.

24. The recording and reproducing device according to claim 15, wherein the optical disk includes grooves having different track pitches in each region of the optical disk,
the region having the predetermined track pitch is a region having a wide track pitch among the regions having different track pitches, and
the recording and reproducing execution portion records and reproduces information on the optical disk in a region having a narrow track pitch among the regions having different track pitches.

25. The recording and reproducing device according to claim 15, wherein the region having the predetermined track pitch is a region having a track pitch which is twice or more the diameter of the light spot for recording and reproducing information on the optical disk.

26. The recording and reproducing device according to claim 25, wherein the optical disk includes grooves having different track pitches in each region of the optical disk,
the region having the predetermined track pitch is a region having a wide track pitch among the regions having different track pitches, and
a region having a narrow track pitch among the regions having different track pitches is a region having a track pitch which is twice or less the diameter of the light spot.

27. The recording and reproducing device according to claim 15, wherein a value of (TPW/λ)*NA is within the range of 3.69-4.95 when TPW represents the track pitch of the region having the predetermined track pitch, λ represents a wavelength of light that is irradiated onto the optical disk, and NA represents a numerical aperture of an objective lens for condensing light.

28. The recording and reproducing device according to claim 27, wherein the optical disk includes grooves having different track pitches in each region of the optical disk,
the region having the predetermined track pitch is a region having a wide track pitch among the regions having different track pitches, and
a value of (TPS/λ)*NA is within the range of 0.61-0.73 when TPS represents a track pitch of a region having a narrow track pitch among the regions having different track pitches.

29. A semiconductor circuit for adjusting a control parameter for recording and reproducing control of the optical disk, comprising:
a detected signal obtaining portion for obtaining a detected signal that is detected from an region having a predetermined track pitch on the optical disk; and
a parameter adjustment portion for adjusting a control parameter of the recording and reproducing control by using the obtained detected signal.

30. The recording and reproducing method according to claim 2, wherein the tracking control signal is a tracking error signal that is a differential output of a photo detector portion for detecting reflected light of the light spot, and step (a) includes adjusting the control parameter so that a signal amplitude of the tracking error signal becomes the maximum value.

31. The recording and reproducing method according to claim 5, wherein step (a) includes finding optimal control positions for the focus control and the aberration correction control in the region having the predetermined track pitch.

32. The recording and reproducing device according to claim 16, wherein the tracking control signal is a tracking error signal that is a differential output of a light reception portion for receiving reflected light of the light spot, and the parameter adjustment portion adjusts the control parameter so that a signal amplitude of the tracking error signal becomes the maximum value.

33. The recording and reproducing device according to claim 19, wherein the parameter adjustment portion finds optimal control positions for the focus control and the aberration correction control in the region having the predetermined track pitch.
